(19) United States
(12) Patent Application Publication
(10) Pub. No.: US 2026/0311347 A1
(43) Pub. Date: Oct. 8, 2026

(54) OBJECT RECOGNITION METHOD AND OBJECT RECOGNITION DEVICE

(71) Applicant: Nissan Motor Co., Ltd., Yokohama-shi, Kanagawa (JP)

(72) Inventor: Akinobu IKEDA, Kanagawa (JP)

(21) Appl. No.: 19/482,288

(22) PCT Filed: May 26, 2023
(86) PCT No.: PCT/JP2023/019783

§ 371 Date: Nov. 7, 2025

(51) Int. Cl. G06T 7/246; G06T 7/254

(52) U.S. Cl. CPC G06T 7/248; G06T 7/254; G06T 2207/10016; G06T 2207/20224; G06T 2207/30232

(57) ABSTRACT

A moving object recognition method by a computer includes acquiring a plurality of surrounding images in a time series obtained by capturing surroundings a plurality of times in a time series. A row image is extracted at a prescribed position in a vertical direction from each of the plurality of surrounding images in the time series. A time-series image is generated in which the extracted row images are arranged in the vertical direction in a time series order. A moving object is recognized moving in the surroundings from the plurality of surrounding images in the time series based on a difference between the row images of the time-series image in a horizontal position of a feature point at which a feature quantity in the row images varies.

### CROSS-REFERENCE TO RELATED APPLICATIONS

This application is a U.S. national stage application of International Application No. PCT/JP2023/019783, filed on May 26, 2023.

### BACKGROUND

### Technical Field

The present invention relates to a moving object recognition method and a moving object recognition device.

### Background Information

In an object detection device of Japanese Unexamined Patent Publication No. 2016-24602, optical flow relating to a moving direction of a time series of each pixel is calculated in a captured image, and calculation results are grouped. Then, a three-dimensional stationary object region and a moving object region are estimated from the grouped calculation results. The object detection device detects a boundary between an estimated three-dimensional stationary object region and an estimated moving object region, and detects a protruding object in the image of the moving object region.

### SUMMARY

Textures of two objects that partially overlap with each other in a captured image are continuous without any gaps in the vicinity of a boundary between both objects. When textures of the two objects are continuous, it becomes difficult to correctly track optical flow of each object from a captured image. An object of the present invention is to suitably recognize a moving object in the background partially hidden by an object in the foreground.

A moving object recognition method and a moving object recognition device according to an embodiment of the present invention to solve the problems above include: acquiring a plurality of surrounding images in a time series obtained by capturing surroundings a plurality of times in a time series; and recognizing by a computer a moving object moving in the surroundings from the plurality of surrounding images in the time series. The method and device include: extracting a row image at a prescribed position in a vertical direction from each of the plurality of surrounding images in the time series; and generating a time-series image in which the extracted row images are arranged in the vertical direction in a time series order. The method and device also include recognizing the moving object based on a difference between the row images of the time-series image in a horizontal position of a feature point at which a feature quantity in the row images varies.

According to the present invention, a moving object in the background partially hidden by an object in the foreground can be suitably recognized.

### BRIEF DESCRIPTION OF DRAWINGS

Referring now to the attached drawings which form a part of this original disclosure, illustrative embodiments are shown.

FIG. 1 is a diagram illustrating a vehicle equipped with a moving object recognition device according to a first embodiment.

FIG. 2 is a diagram illustrating an example of a time-series image generation process.

FIG. 3 is a diagram illustrating an example of a feature image generation process.

FIG. 4 is a diagram illustrating an approximate straight line component of a set of feature points.

FIG. 5 is a distribution diagram of the slope and the perpendicular length of the straight line component of the feature points.

FIG. 6 is a diagram illustrating allocation of moving feature points to objects in a surrounding image.

FIG. 7 is a flowchart illustrating an example of a moving object recognition procedure.

FIG. 8 is a flowchart illustrating an example of a time-series image generation procedure.

FIG. 9 is a flowchart illustrating an example of a moving object recognition procedure.

FIG. 10 is a diagram illustrating a vehicle equipped with a moving object recognition device according to a second embodiment.

FIG. 11 is a flowchart illustrating an example of a moving object recognition procedure.

### DETAILED DESCRIPTION OF EMBODIMENTS

Hereinafter, embodiments of the present invention will be described with reference to the drawings. In the description of the drawings, the same parts are denoted by the same reference signs, and description thereof will be omitted.

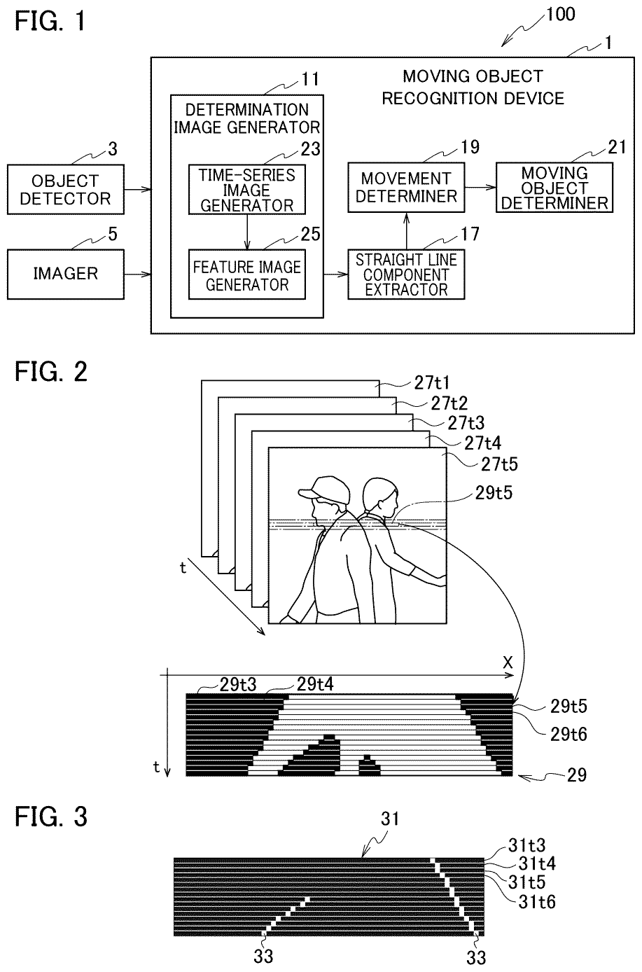

As illustrated in FIG. 1, a vehicle 100 includes a moving object recognition device 1, an object detector 3, and an imager 5. When the vehicle 100 starts traveling, the moving object recognition device 1 determines the presence of an object moving around the vehicle 100 by using the distance from a distance measurement point detected by the object detector 3 to an object around the vehicle 100, and an image captured by the imager 5.

The object detector 3 measures a relative position from the vehicle 100 to the object, which is present around the vehicle 100. The relative position measured by the object detector 3 may be, for example, a relative position with respect to an imaging position at which an image is captured by the imager 5 described below. The relative position measured by the object detector 3 includes information on the distance from the vehicle 100 to the object. When the relative position measured by the object detector 3 is based on the imaging position, the information on the distance can be handled as information on the distance from the imaging position to the object. The detected relative position is output to the moving object recognition device 1, and stored in a memory (not illustrated). The object detector 3 may be any sensor that can detect the distance to the object present around the vehicle 100. For example, a stereo camera can be used as the object detector 3. A LiDAR (Light Detection and Ranging), a laser radar, or a ToF (Time of Flight) camera can be used as the object detector 3. The imager 5 can be configured, for example, by a camera that captures an image. The camera includes an imaging device such as a CCD (Charge-Coupled Device) or a CMOS (Complementary Metal Oxide Semiconductor). The imager 5 is mounted in the vehicle 100 and captures a surrounding image. The surrounding image of the vehicle 100 captured by the imager 5 is output to the moving object recognition device 1, and stored in a memory (not illustrated).

The moving object recognition device 1 is mounted in the vehicle 100, and recognizes an object present in the surroundings. In particular, the moving object recognition device 1 extracts a row image at a prescribed position in a vertical direction from each of a plurality of surrounding images in a time series captured a plurality of times by the imager 5, and generates a time-series image in which the plurality of extracted row images are arranged in the vertical direction in the time series. The moving object recognition device 1 can determine the presence of a moving object moving in the surroundings of the vehicle 100 based on a difference in the horizontal position of a feature point at which a feature quantity in a row image varies between the row images of the generated time-series image. The moving object recognition device 1 includes, for example, a general-purpose microcontroller as a computer. The microcontroller includes a CPU (Central Processing Unit) and a memory. The memory includes a ROM (Read Only Memory) and a RAM (Random Access Memory). The microcontroller can virtually construct a plurality of information processing circuits by having the CPU execute a program stored in the memory.

FIG. 1 illustrates the moving object recognition device 1 according to a first embodiment. The moving object recognition device 1 can implement the moving object recognition method according to the first embodiment. In the moving object recognition device 1 according to this embodiment, a plurality of information processing circuits of the microcontroller can constitute a determination image generator 11, a straight line component extractor 17, a movement determiner 19, and a moving object determiner 21 of the moving object recognition device 1. In this embodiment, an example of realizing a plurality of information processing circuits by software is shown. Of course, dedicated hardware for executing the following information processing of the respective units 11 and 17 to 21 may be prepared to constitute the information processing circuits. Alternatively, a plurality of information processing circuits may be constituted by individual hardware components. The dedicated hardware includes an application-specific integrated circuit (ASIC) configured to execute the functions of the respective units 11, and 17 to 21, and a device such as a conventional circuit component.

The determination image generator 11 receives the surrounding images captured by the imager 5 a plurality of times. The determination image generator 11 generates time-series feature images from the received surrounding images. The determination image generator 11 includes a time-series image generator 23 and a feature image generator 25. The time-series image generator 23 generates time-series images from a plurality of received surrounding images in a time-series order. The feature image generator 25 converts the received surrounding images into feature images. The determination image generator 11 generates time-series feature images by sequentially performing time-series image generation using the time-series image generator 23, and conversion into feature images using the feature image generator 25, for a plurality of surrounding images in the time-series. Either time-series image generation using the time-series image generator 23, or conversion into feature images using the feature image generator 25, may be performed first. When time-series image generation is performed first, the feature image generator 25 converts the time-series images generated by the time-series image generator 23 into feature images to generate time-series feature images. When conversion into feature images is performed first, the time-series feature images are generated by the time-series image generator 23 using a plurality of feature images in the time-series converted from a plurality of surrounding images in the time-series by the feature image generator 25. In the following description, it is assumed that time-series image generation using the time-series image generator 23 is performed first, and conversion into feature images using the feature image generator 25 is performed afterward.

The plurality of time-series images are input to the time-series image generator 23. The time-series image generator 23 generates a time-series image representing time changes of the plurality of images input to the time-series image generator 23 for each row. FIG. 2 illustrates a case where the plurality of time-series images input to the time-series image generator 23 include surrounding images 27t1 to 27t5, captured a plurality of times by the imager 5. Pieces of time-series image data may be input to the time-series image generator 23 one by one at any time, or may be input every time a prescribed number of pieces of time-series image data are accumulated. A cycle for generating time-series images by the time-series image generator 23 illustrated in FIG. 1 may be longer than a cycle for capturing surrounding images by the imager 5. When generating time-series images using the surrounding images of the imager 5, the time-series image generator 23 may use the number of surrounding images captured by the imager 5 during one cycle for generating time-series images, or may use a larger or smaller number of surrounding images. For example, when the imager 5 captures ten surrounding images during one cycle for generating time-series images, the time-series image generator 23 may generate time-series images for each cycle using the 0 to 20th, 10 to 30th, and 20th to 40th surrounding images in the 1st to 3rd cycle. Alternatively, the time-series image generator 23 may generate time-series images using the 0 to 5th surrounding images in the 1st cycle, the 10th to 15th surrounding images in the 2nd cycle, and the 20th to 25th surrounding images in the 3rd cycle.

The images used by the time-series image generator 23 for generating time-series images may partially overlap in the preceding and following processes, and some images need not be used for generating time-series images. The number of images used for generating time-series images should be as large as possible, for example, within a short unit time in which the time-series movement of a feature point in the time-series image in the horizontal direction can be approximated by a straight line. The larger the number of images used for generating time-series images, the higher the resolution with which the horizontal movement of the feature point in the time-series image can be determined. If an imaging cycle of surrounding images using the imager 5 is short when a time-series image is generated using the surrounding images of the imager 5, an object movement acceleration in the surrounding image can be ignored as much as possible. If the object movement acceleration can be ignored, it becomes easier to approximate the movement amount of the object in the surrounding image to a straight line by tracing the position of the object in each cycle.

The time-series image generator 23 extracts row images at prescribed positions in the vertical direction from the images input to the time-series image generator 23, and generates a time-series image in which a plurality of the extracted row images are arranged in the vertical direction in the time-series order. FIG. 2 illustrates a case where a row image 29t5 extracted from a prescribed position in the vertical direction of the surrounding image 27t5, and row images 29t3, 29t4, 29t6, and the like, extracted from prescribed positions in the vertical direction of other surrounding images, are arranged in the vertical direction in the time-series order to generate a time-series image 29. Information on the movement of the object in the horizontal direction remains in the row images. In the detection of a moving object performed in the vehicle 100, a horizontally moving object may advance from outside the path of the vehicle 100 into the path of the vehicle 100, for example, and may be an important detection target. Pieces of information on movement of the object in the horizontal direction, which appear in the row images at prescribed positions of respective surrounding images in the vertical direction, are arranged in the time-series image 29, in the vertical direction of the time-series image 29 in the time-series order.

As illustrated in FIG. 2, when generating the time-series image 29, only a portion of the row image 29t5 in the horizontal direction may be used rather than the entire horizontal width. When a part of the row image 29t5 is used to generate the time-series image 29, the part of the row image used to generate the time-series image 29 may be, for example, a part in the same range in the horizontal direction of each surrounding image by default. The prescribed position of each surrounding image in the vertical direction means a position where the contents appear in the row images at that position are common among the surrounding images. The prescribed position in the vertical direction of each surrounding image may be, for example, a position of the same number of rows among a plurality of rows arranged in the vertical direction of each surrounding image by default. The prescribed position of each surrounding image may be shifted to a position of a different row among the surrounding images in accordance with, for example, a change in the imaging range of each surrounding image accompanying the movement of the vehicle 100. For example, when a region such as the sky or a road surface clearly different from an object moving around the vehicle 100 appears in the surrounding images, the row images in that region may be excluded from a target for generating the time-series image 29. Although the resolution for determining a moving object is improved as the number of rows for generating the time-series image 29 increases in the row images extracted from the surrounding images, the rows for generating the time-series image 29 may be thinned out in consideration of the balance between processing cost and required accuracy.

The feature image generator 25 illustrated in FIG. 1 converts an image input to the feature image generator 25 into a feature image. The feature image represents a feature point whose feature quantity varies in a horizontal direction of the image. The feature quantity may be, for example, luminance or hue. The more types of features that the image input to the feature image generator 25 is converted into feature images for, the more the accuracy of straight line component extraction in the straight line component extractor 17 described below improves. For example, when the feature quantity is luminance, the feature point may be, for example, a point at which a differential value of luminance representing a variation of the feature quantity between adjacent pixels in the horizontal direction, becomes a negative value. The feature point may be a point at which a differential value of luminance becomes a positive value, or both a point at which a differential value of luminance becomes a negative value, and a point at which a differential value of luminance a becomes a positive value, may be used as the feature point. The feature point may be a pixel having a maximum luminance or a minimum luminance in each row. For example, when the feature value is hue, the feature point may be a differential value of each color of RGB (Red, Green, Blue) or a differential value of hue between adjacent pixels in the horizontal direction. The feature point may be, for example, an edge portion in an image input to the feature image generator 25. The edge portion may be detected using a known algorithm. As the known algorithm, for example, an edge detection method using a Sobel filter, an edge detection method using a Laplacian filter, a Kenny method, or the like may be used. When the time-series change of the detected edge portion is obtained, movement of the feature point in the surrounding image can be detected. When the image input to the feature image generator 25 is converted into a feature image, a process for removing noise from the input image may be performed. For the removal of noise, for example, a normalization process by a median filter, binarization, or the like may be used. The conversion of the image to the feature image may be performed by processing that also removes noise.

FIG. 3 illustrates a time-series feature image 31 obtained by converting the time-series image 29 of FIG. 2 into a feature image, where luminance is used as the feature quantity. In the time-series feature image 31 of FIG. 3, a plurality of row feature images including row feature images 31t3 to 31t6 obtained by converting each row image 29t3 to 29t6 of FIG. 2 are arranged in the vertical direction in the time series order. In FIG. 3 a feature point is indicated by 33. In FIG. 3, the feature point 33 is a pixel in which the differential value of luminance between adjacent pixels becomes a negative value, and has a gradient from light to dark. The feature point 33 may be a pixel in which the differential value of luminance between adjacent pixels becomes a positive value and has a gradient from dark to light. The feature point 33 may be an absolute value of the differential value of luminance between adjacent pixels. When the feature point 33 is a differential value of luminance between adjacent pixels, the time-series feature image 31 is obtained by extracting an edge portion of an image input to the feature image generator 25 as the feature point 33.

In the determination image generator 11 of the present embodiment illustrated in FIG. 1, the time-series image generator 23 generates the time-series image first, and the feature image generator 25 converts the time-series image into the feature image afterward. In the generation of the time-series feature image 31 by the determination image generator 11, noise in the surrounding images can be efficiently removed when the feature image generator 25 converts the time-series image into the feature image.

The straight line component extractor 17 extracts a straight line component including the feature points 33 that extend vertically across a plurality of row images from the time-series feature image 31 generated by the determination image generator 11. In the time-series feature image 31, the feature points 33 extending in a t-axis direction of the time-series feature image 31 mean the feature points 33 that continuously exist in the time-series in a row of the surrounding images corresponding to the time-series feature image 31. Since the X-axis of the time-series feature image 31 is a horizontal axis of the surrounding images, when the feature points 33 that extend in the t-axis direction move in the X-axis direction of the time-series feature image 31 in the time-series, the feature points 33 that continuously exist in the time-series move in the horizontal direction of the surrounding images. In the time-series feature images 31, by estimating a straight line that approximates a set of the feature points 33 that extend in the t-axis direction and evaluating the slope of the approximate straight line with respect to the t-axis, the feature points 33 that move in the horizontal direction in a row of the surrounding images corresponding to the time-series feature images 31 can be determined. The feature points 33 that extend vertically in the time-series feature image 31 are a set of points, not a line. The straight line component extractor 17 estimates a straight line that approximates a set of the feature points 33, and extracts the estimated straight line as a straight line component of the feature points 33. The straight line that approximates a set of the feature points 33 can be estimated using a known method. Hereinafter, a case where the approximate straight line of the set of feature points 33 is estimated by the Hough transform will be described.

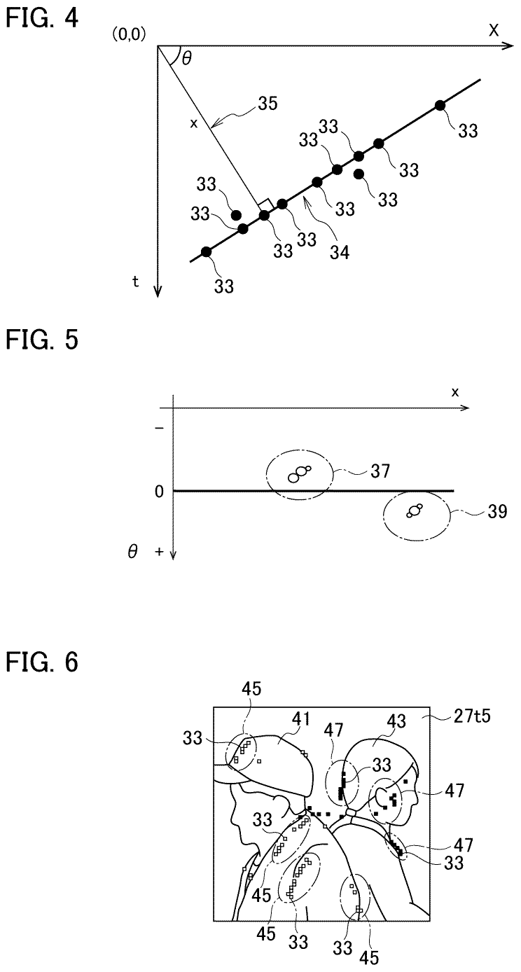

When the approximate straight line with the set of feature points 33 is estimated by the Hough transform, as illustrated in FIG. 4, an estimated approximate straight line 34 is represented by a slope θ and a length x in a space of the X-t plane coordinate system in which the time-series feature image 31 exists. The slope θ is an angle formed by the X-axis of the time-series feature image 31 and a perpendicular line 35 drawn from the approximate straight line 34 to the origin (X, t)=(0,0) of the X-t plane coordinate system. The length x is the length of the perpendicular line 35. The slope θ is positive (θ>0) when the perpendicular line 35 is inclined in the clockwise direction with respect to the X-axis of the time-series feature image 31, and negative (θ<0) when the perpendicular line 35 is inclined in the counterclockwise direction with respect to the X-axis. A positive slope θ means that in the set of feature points 33 approximated by the estimated straight line, the feature points 33 move in the left direction in the time series in the row image corresponding to the time-series feature image 31 of the surrounding image. A negative slope θ means that in the set of feature points 33 approximated by the estimated straight line, the feature points 33 move in the right direction in the time series in the row image corresponding to the time-series feature image 31 of the surrounding image. The magnitude of the slope θ is proportional to the moving speed of the feature points 33 in the row images.

The straight line component extractor 17 outputs a set of the slope θ and the length x of the perpendicular line 35 of the approximate straight line 34 estimated by Hough transformation from one time-series feature image 31, and a score as a straight line component of the set to the movement determiner 19 as a straight line component of the feature points 33 extracted from the time-series feature image 31. The score as a straight line component may be higher, for example, as the set of feature points 33 of the time-series feature image 31 extends longer in the t-axis direction of the time-series feature image 31. The straight line component of the feature points 33 extracted by the straight line component extractor 17 includes a straight line component extracted from the time-series feature image 31 in a row without a reference sign in the time-series image 29 of FIG. 2, and a straight line component extracted from the time-series feature image 31 in a row not illustrated in the time-series image 29 of FIG. 2. When a plurality of feature points 33 moving in the horizontal direction at different positions exist in a row of the surrounding images corresponding to the time-series feature image 31, a plurality of straight lines approximating the set of feature points 33 are estimated from one time-series feature image 31. When the set of feature points 33 of the time-series feature image 31 corresponding to one feature point 33 moving horizontally does not exist on a straight line, and the set of feature points 33 can be approximated to a plurality of straight lines, a plurality of straight lines approximating the set of feature points 33 are estimated from one time-series feature image 31. When a plurality of approximate straight lines are estimated from one time-series feature image 31, the straight line component extractor 17 outputs the slope θ, the length x of the perpendicular line, and the score of each approximate straight line to the movement determiner 19 as a plurality of straight line components of the feature points 33 extracted from one time-series feature image 31.

The movement determiner 19 determines a moving feature point for each row of the surrounding image of FIG. 2, based on the straight line component of the feature points 33 of the time-series image for each row of the surrounding image of FIG. 2 input from the straight line component extractor 17. The moving feature point is a feature point 33 moving horizontally in a row among the feature points 33. When there are a plurality of straight line components of the feature points 33 in each row, the movement determiner 19 groups the respective straight line components into straight line components for each feature point 33 moving horizontally at different positions. The straight line components of the feature points 33, which are considered to correspond to the same feature point 33, are sorted into the same group even though the contents of the straight line components do not match. It is considered that the straight line components of the feature points 33 moving horizontally at different positions have different slopes θ of the approximate straight lines 34, or different lengths x of the perpendicular lines 35. When the straight line components of the feature points 33 are considered to correspond to the same feature points 33 even though the contents of the straight line components do not match, the straight line components are considered to have corresponding or similar slopes θ of the approximate straight lines 34 or corresponding or similar lengths x of the perpendicular lines 35, and different scores. The slope θ of the approximate straight line 34 and the length x of the perpendicular line 35 are parameters corresponding to the moving direction and the straight line component of the moving feature point, and can be used for grouping the straight line components when there are a plurality of straight line components of the feature points 33 in each row. The movement determiner 19 can sort the straight line components of the feature points 33 moving in the horizontal direction at different positions by the slope θ of the approximate straight line 34 and the length x of the perpendicular line 35.

The movement determiner 19 plots points corresponding to the slope θ and the length x of the perpendicular line 35, with respect to the approximate straight line 34 of each straight line component of the feature points 33 extracted from the time-series feature image 31 on the x-0 plane coordinates for the time-series feature image 31 in each row. The straight line component of the feature points 33 for plotting the points corresponding to the slope θ and the length x of the perpendicular line 35 on the x-θ plane coordinates may be limited to the straight line component having a score equal to or greater than a prescribed threshold. When the difference between the two straight line components of the feature points 33 with respect to the slope θ and the length x of the perpendicular line of the approximate straight line 34 is within a prescribed range, the movement determiner 19 may sort the two straight line components of the feature points 33 into the same group, assuming that the parameter difference corresponding to the straight line components of the feature points 33 is within a prescribed range.

FIG. 5 illustrates the distribution of the slope θ and the length x of the perpendicular line with respect to the approximate straight line 34 of the straight line component of the feature points 33 extracted from the time-series feature image 31 in FIG. 3. On the x-θ plane coordinates in FIG. 5, there exist a region 37 in the quadrant where the slope θ is negative and the length x of the perpendicular line is positive, and a region 39 in the quadrant where the slope θ is positive and the length x of the perpendicular line is positive. In the regions 37 and 39, points corresponding to the slope θ and the length x of the perpendicular line of the straight line component are concentrated. The points concentrated in the region 37 of the quadrant in which the slope θ is negative correspond to a set of feature points 33 existing on the right side of the time-series feature image 31 in FIG. 3, extending from the upper left to the lower right. The points concentrated in the region 39 of the quadrant in which the slope θ is positive, as illustrated in FIG. 5, correspond to a set of feature points 33 existing on the left side of the time-series feature image 31 in FIG. 3, extending from the upper right to the lower left. The slopes θ or the lengths x of the perpendicular lines of the approximate straight lines indicated by the points in the regions 37 and 39 in FIG. 5 correspond to, or are similar to each other for each region 37 and region 39. The straight line components of the feature points 33 corresponding to the points concentrated in the regions 37 and 39 are considered to be a set of straight line components corresponding to one feature point 33 moving in the horizontal direction. The movement determiner 19 determines that the plurality of straight line components of the feature points 33 corresponding to the points concentrated in the region 37, and the plurality of straight line components of the feature points 33 corresponding to the points concentrated in the region 39, are each one moving feature point. The movement determiner 19 outputs, to the moving object determiner 21, the slope θ of the approximate straight line 34 with respect to the feature points 33 determined to be the moving feature point, and information of the row of the time-series feature image 31 corresponding to the feature points 33, as the information of the moving feature point in the row image. The slope θ of the approximate straight line 34 with respect to the feature points 33 that is determined to be the moving feature point can be used as the information of a moving direction and a moving speed of the moving feature point in the horizontal direction. The information of the moving feature point can be used when the moving object determiner 21 determines the presence of an object moving around the vehicle 100 based on the moving speed in the horizontal direction of the feature point 33, represented by the slope θ of the approximate straight line 34 with respect to the feature point 33 in the time-series feature image 31.

The moving object determiner 21 determines the presence of an object moving around the vehicle 100. In particular, the moving object determiner 21 determines an object moving horizontally in the surrounding image based on the moving feature point determined with respect to the time-series feature image 31 of each row which is the information of the moving feature point received from the moving object determiner 19. The moving object determiner 21 clusters the moving feature point of each row determined by the moving object determiner 19 according to the moving direction and moving speed in the horizontal direction of the row image. The moving object determiner 21 clusters the moving feature points and groups the moving feature points whose moving direction and moving speed are close to each other into the same cluster. A set of moving feature points of each of the grouped clusters is determined as a moving feature point of one object. Existing methods such as the k-means method, which is a non-hierarchical clustering algorithm, and hierarchical clustering, can be used for clustering the moving feature points, for example. In FIG. 6, the feature points 33 corresponding to the moving feature points sorted into two groups are allocated to two persons 41 and 43 moving on the surrounding image 27t5 of FIG. 2. In FIG. 6, the moving object determiner 21 sorts the feature points 33 corresponding to the moving feature points into two groups which are similar with respect to moving direction and moving speed. Each group is a set of the feature points 33 moving leftward and rightward in the surrounding image, and is indicated by different symbols (□, [symbol] ) in FIG. 6. The moving object determiner 21 determines the person 41 moving leftward on the surrounding image 27t5 of FIG. 2 by the set 45 of the feature points 33 moving leftward, and determines the person 41 moving rightward on the surrounding image 27t5 by the set 47 of the feature points 33 moving rightward.

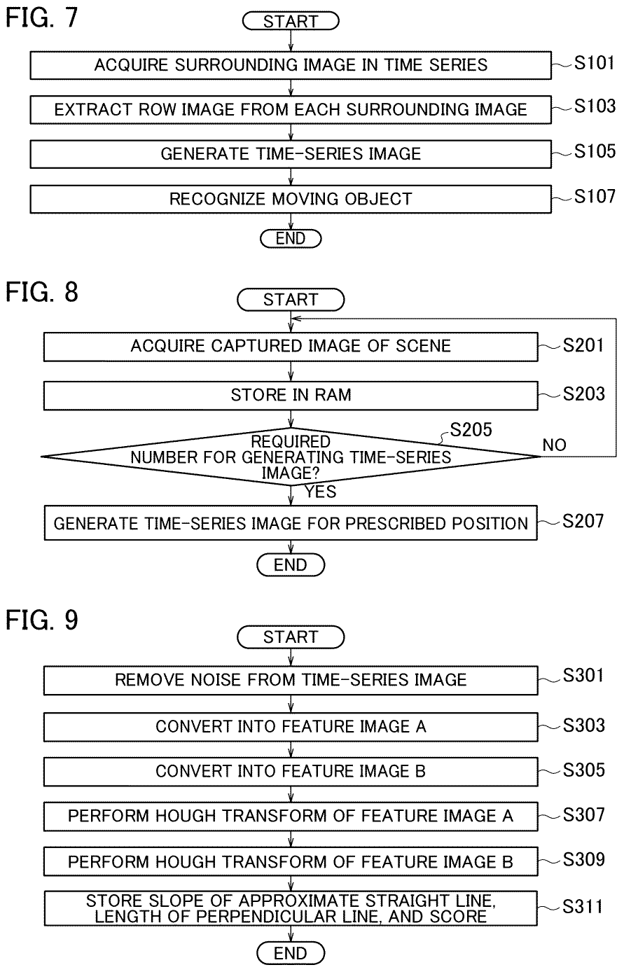

FIG. 7 is a flowchart illustrating a processing procedure performed by a microcontroller for recognizing a moving object. As illustrated in FIG. 7, the microcontroller acquires a plurality of surrounding images in a time series captured a plurality of times by the imager 5 (step S101). The time-series image generator 23 of the microcontroller extracts a row image at a prescribed position in the vertical direction from each acquired surrounding image in a time series (step S103). The microcontroller generates a time-series image in which the plurality of extracted row images are arranged in time-series order (step S105). The microcontroller recognizes a moving object based on a difference in the horizontal position of a feature point at which the feature quantity in the row images varies between the row images of the generated time-series image 29 (step S107). The microcontroller recognizes a moving object based on the time-series feature image 31 generated by using the time-series image 29 generated by the time-series image generator 23. The process of step S107 can be performed by, for example, the feature image generator 25, the straight line component extractor 17, the movement determiner 19, and the moving object determiner 21.

The flowchart of FIG. 8 illustrates an outline of a procedure performed by the time-series image generator 23 of the microcontroller for generating the time-series image 29. The procedure illustrated in FIG. 8 can be a detailed procedure when, for example, the time-series image generator 23 performs processing of steps S101 to S105 of FIG. 7. As illustrated in FIG. 8, the time-series image generator 23 acquires an image captured by the imager 5 as a surrounding image, which is a scene around the vehicle 100 (step S201). The time-series image generator 23 stores the acquired surrounding image in the RAM of the memory of the microcontroller (step S203). The time-series image generator 23 checks whether the number of surrounding images in the RAM has reached a required number for generating the time-series image 29 (step S205). If the number of surrounding images in the RAM has not reached the required number (NO in step S205), the process returns to step S201. If the number of surrounding images in the RAM has reached the required number (YES in step S205), the time-series image generator 23 generates the time-series image 29 by using a row image at a prescribed position in the vertical direction extracted from a plurality of surrounding images of the time-series stored in the RAM (step S207).

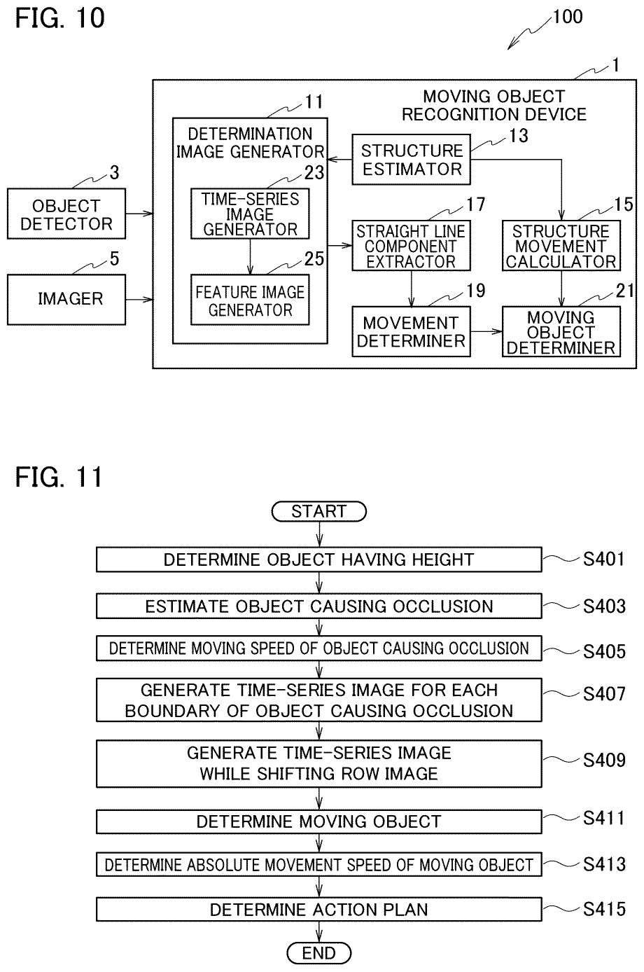

The flowchart of FIG. 9 illustrates an outline of a procedure performed when the microcontroller extracts a plurality of straight line components of the feature points 33 from the time-series feature image 31 generated by using the time-series image 29. The processing procedure illustrated in FIG. 9 can be a detailed processing procedure when, for example, a partial process of step S107 in FIG. 7 is performed by the feature image generator 25 and the straight line component extractor 17. As illustrated in FIG. 9, the feature image generator 25 removes noise from the time-series image 29 generated by the time-series image generator 23 (step S301). Normalization processing by a median filter, binarization, or the like can be used for the removal of noise, for example. The feature image generator 25 converts the time-series image 29 after the noise removal into a feature image A and a feature image B using kernel A and kernel B of the Sobel filter (Step S303 and step S305). By the conversion to the feature image A, the time-series feature image 31 from which the edge portion in the horizontal direction of the time-series image 29 is extracted is obtained. By the conversion to the feature image B, the time-series feature image 31 from which the edge portion in the vertical direction of the time-series image 29 is extracted is obtained. In steps S303 and S305, pixels having a gradient from light to dark and having a negative pixel value as a result of applying the Sobel filter are extracted. In steps S303 and S305, pixels having a gradient from dark to light and having a positive pixel value as a result of applying the Sobel filter may be extracted. In steps S303 and S305, both pixels having a positive pixel value and pixels having a negative pixel value as a result of applying the Sobel filter may be extracted. Either of the processes in steps S303 and S305 may be performed first, or both may be performed in parallel. Either of the processes in steps S303 and S305 may be omitted. The straight line component extractor 17 performs Hough transform on each time-series feature image 31 obtained by converting the time-series image 29 into the feature image A and the feature image B by the feature image generator 25 (step S 307, step S309). The straight line component extractor 17 can estimate the approximate straight line 34 of a set of the feature points 33 of each time-series feature image 31 by Hough transform on each time-series feature image 31. When either of the processes in steps S303 and S305 is omitted, either of the processes in steps S307 and S309 may be omitted. The straight line component extractor 17 stores the slope θ of the approximate straight line 34 of the feature points 33 extracted by Hough transform on the time-series feature image 31, the length x of the perpendicular line 35, and the score in the RAM of the memory of the microcontroller (step S311).

In the present embodiment, row images at prescribed positions in the vertical direction extracted from a plurality of surrounding images in the time series are arranged in the time series to generate the time-series image 29, thereby deleting information on the movement of the object in the vertical direction, which appears in the surrounding images, and arranging information on the movement of the object in the horizontal direction in the time series. By generating the time-series feature image 31 obtained by converting the time-series image 29 into a feature image, the feature points 33 whose feature quantity varies in the horizontal direction are extracted for each row image of the time-series image 29. Since the slope of the straight line component of the feature point 33 in the time-series feature image 31 represents a movement speed in the horizontal direction of a point corresponding to the feature point 33 appearing at a prescribed position in the vertical direction of the surrounding image, a moving feature point that is the feature point 33 moving on the surrounding image can be determined from the slope. The determined moving feature point can be used for recognizing a moving object around the vehicle 100 based on the movement speed in the horizontal direction of the feature point represented by the slope of the straight line component of the feature point 33 in the time-series feature image 31. In this embodiment, a moving object in the background partially hidden by an object in the foreground can be suitably recognized.

In this embodiment, the time-series image generator 23 generates the time-series image 29 by extracting a row image at a prescribed position from an input image, and the feature image generator 25 converts the input image into a feature image as it is without extracting a row image at a prescribed position from the input image. The process for removing noise of the image is efficiently performed for the whole image. By performing the process of the time-series image generator 23 in advance in the determination image generator 11, a noise removal process for the time-series feature image 31 can be efficiently performed when performing the process of the feature image generator 25 after the process of the time-series image generator 23 for extracting a row image from the input image. In this embodiment, the feature image generator 25 generates an image representing an edge portion in a surrounding image as a feature image, and a moving object existing in the surrounding image can be tracked by a time-series change of the edge portion. When tracking the moving object existing in the surrounding image by optical flow, Pixel information of a broader area is required as compared with the edge detection in order to recognize the moving object as a surface. When the movement of the object in the surrounding image is detected by obtaining the time-series change of the edge portion, the movement detection of a small object can be realized as compared with object movement tracking by using optical flow.

Row images in the time-series order are arranged in the vertical direction in the time-series feature image 31. When the straight line component of the feature point 33 extracted from the time-series feature image 31 is not inclined and extends in the vertical direction, which means that the feature point 33 on the surrounding image is not moved in the horizontal direction in the time-series. The direction of the slope of the straight line component of the feature point 33 indicates whether the feature point 33 on the surrounding image has moved to the right or left in the horizontal direction in the time-series. Based on whether the feature point 33 on the surrounding image has moved to the right or left in the horizontal direction in the time-series, the moving feature points can be grouped for each object moving on the surrounding image. The angle of the slope of the straight line component of the feature point 33 includes information on the amount of movement of the feature point 33 in the horizontal direction in the surrounding image and information on time in the time-series, and indicates the moving speed of the feature point 33 that has moved in the horizontal direction on the surrounding image. Based on the moving speed of the feature point 33 in the horizontal direction on the surrounding image, the moving feature points can be grouped for each object moving on the surrounding image.

A plurality of moving feature points determined based on the slope of the straight line component of the feature point 33 extracted from the time-series feature image 31 for each row may include moving feature points corresponding to different objects on the surrounding image. When the plurality of moving feature points are grouped based on the moving direction of the moving feature point in the time-series feature image 31 for each row, and a parameter corresponding to the straight line component of the feature points 33, the moving feature points having the same moving direction and close positions are sorted into the same group. The moving feature points having close moving direction and positions in the time-series feature image 31 may be moving feature points corresponding to a common object on the surrounding images. When the score of the grouped moving feature points is equal to or greater than a prescribed determination threshold, it can be determined that there is an object corresponding to the grouped moving feature points and moving in the surroundings. When the difference between the slopes θ of the approximate straight lines 34 and the lengths x of the perpendicular lines 35, which are parameters corresponding to the straight line components of the feature point 33 on the time-series feature image 31, is within a prescribed range, it is considered that the positions of the two moving feature points are close. Since the difference between the slopes θ of the approximate straight lines 34 is within a prescribed range, it is considered that the moving speed difference between the two moving feature points on the surrounding image is also small. In this case, there is a possibility that the two moving feature points correspond to a common object on the surrounding image. When the positions on the surrounding image are close, and the moving speed difference is less than a prescribed value, the two moving feature points can be grouped into the same group and determined to be moving feature points corresponding to a common object on the surrounding image.

FIG. 10 illustrates the moving object recognition device 1 according to a second embodiment. The object recognition device 1 can implement a moving object recognition method according to the second embodiment. The moving object recognition device 1 according to this embodiment can recognize an object moving outside the boundary of a structure that causes occlusion in the surrounding image of the vehicle 100. In the moving object recognition device 1 according to the present embodiment, a plurality of information processing circuits of a microcontroller can constitute the respective units 11, and 15 to 21, of the moving object recognition device 1 according to the first embodiment, as well as a structure estimator 13 and a structure movement calculator 15. Of course, the information processing circuit may be configured by preparing dedicated hardware for executing the following information processing of the respective units 13 and 15.

The structure estimator 13 estimates an object causing occlusion in the surrounding image. An object causing occlusion, including a structure, hides a moving object in the surrounding image from view. A structure causing occlusion is, for example, a stationary three-dimensional object. The stationary three-dimensional object may include, for example, a permanently existing three-dimensional object such as a building, a three-dimensional object temporarily appearing, such as a construction site or a parked or stopped vehicle, or a permanent structure that has newly appeared. The structure estimator 13 can estimate in advance a permanently existing structure such as a building by using, for example, information acquired beforehand. For the estimation of the permanently existing three-dimensional object, for example, information on high-precision three-dimensional map data (HD map, high definition map), position information using a global navigation satellite system (GNSS) sensor of the vehicle 100, or the like, can be used. A temporary or newly generated three-dimensional object can be estimated from the parallax of the image obtained by the stereo camera of the object detector 3, for example. The permanently existing three-dimensional object may also be estimated from the parallax of the image obtained by the stereo camera of the object detector 3. For example, the structure estimator 13 can estimate an object, which is determined to have a prescribed volume or more from an image captured by the stereo camera of the object detector 3, as a structure causing occlusion. An object causing occlusion is not limited to a structure. An object causing occlusion may include a pedestrian jumping out caution point. The pedestrian jumping out caution point includes, for example, an intersection on terrain with poor visibility.

A structure causing occlusion may move in the surrounding image by, for example, the movement of the vehicle 100. The structure movement calculator 15 calculates the moving direction and moving speed of the structure causing occlusion in the surrounding image. The moving direction and moving speed of the structure to be an object causing occlusion in the surrounding image can be calculated by tracing the movement of the structure estimated by the structure estimator 13 in the surrounding image. The movement of the structure in the surrounding image can be traced by, for example, optical flow, template matching, or the like. The movement of the structure in the surrounding image may be estimated by, for example, using the distance from the imaging position detected by the object detector 3 to the structure, and the self-position detection result of the vehicle 100 by odometry. When the structure causing occlusion moves in the surrounding image, the time-series image generator 23 may shift the position of the row image, which is used for generating the time-series image 29 or the time-series feature image 31 in the surrounding image, in at least one of the vertical direction or in the horizontal direction of the surrounding image. In this embodiment, the time-series image generator 23 shifts the position of the row image used for generating the time-series image 29 because the time-series image generator 23 generates the time-series image 29 prior to conversion to the feature image by the feature image generator 25. The time-series image generator 23 may shift the position of the row image used for generating the time-series image 29 based on the moving direction and moving speed of the structure causing occlusion in the surrounding image calculated by the structure movement calculator 15. The time-series image generator 23 may shift the prescribed position of the row image used for generating the time-series image 29 in the vertical direction of the surrounding image, or may shift the portion of the row image used for generating the time-series image 29 in the horizontal direction of the surrounding image.

The moving object determiner 21 of this embodiment may determine an object moving in the horizontal direction in the surrounding image exclusively within a surrounding region of the boundary of a structure causing occlusion. For this purpose, the movement determiner 19 may determine the moving feature point exclusively within the surrounding region, and the straight line component extractor 17 may extract the straight line component of the feature point 33 exclusively within the surrounding region. For this purpose, the determination image generator 11 may generate the time-series feature image 31 exclusively within the surrounding region, and perform generation of the time-series image 29 by the time-series image generator 23 and conversion of the image into the feature image by the feature image generator 25 exclusively within the surrounding region.

A flowchart of FIG. 11 illustrates an outline of a procedure for determining an object moving outside the boundary of the structure causing occlusion. The microcontroller extracts an object having a height and existing around the vehicle 100 from an image captured by a stereo camera of the object detector 3 (step S401). The microcontroller estimates an object determined to have a prescribed volume or more among the extracted objects as a structure causing occlusion (step S403). The microcontroller extracts a feature point of the occluding structure from the captured image of the object detector 3, and tracks the extracted feature point in time series to determine a moving speed of the structure causing occlusion in the surrounding image of the imager 5 (step S405). For example, optical flow can be used to track the feature point. The moving speed to be determined includes information on a moving direction of the structure causing occlusion in the surrounding image. The microcontroller extracts a boundary of the structure causing occlusion. The boundary is an outline of the structure causing occlusion. The extracted boundary includes at least a portion of the occluding structure that is a boundary of the structure causing occlusion in the horizontal direction of the surrounding image. The time-series image generator 23 of the microcontroller generates the time-series image 29 for each of the extracted boundaries (step S407). When the structure causing occlusion moves in the surrounding image, the time-series image generator 23 generates the time-series image 29 while shifting the position of the row image in at least one of the vertical direction or the horizontal direction of the surrounding image in accordance with the speed and direction of the movement (step S409). The process of step S409 can be performed as a process for correcting the time-series image 29 generated in the process of step S407 as necessary.

The microcontroller determines a moving object moving from the boundary of the structure causing occlusion to the outside of the structure causing occlusion based on the time-series feature image 31 produced using the time-series image 29 generated by the time-series image generator 23 (step 411). The process of step 411 can be performed by the feature image generator 25, the straight line component extractor 17, the movement determiner 19, and the moving object determiner 21. The microcontroller determines the absolute movement speed of the moving object in the space around the vehicle 100 (step 413). The absolute movement speed of the object can be determined, for example, by using the distance between the object and the imaging position detected by the object detector 3, and using the movement content of the imaging position based on the self-position detection result of the vehicle 100 by odometry. The microcontroller determines an action plan of the vehicle 100 from the determined absolute speed (step 415). The action plan of the vehicle 100 may be determined by a controller of a drive control system of the vehicle 100 instead of the microcontroller. The controller of the driving control system of the vehicle 100 may be, for example, an automatic driving ECU (Electronic Control Unit).

There is a possibility that an object protruding from behind a structure may appear in a surrounding region of the boundary of the structure present in the surrounding image. In this embodiment, the presence of an object moving in the surroundings can be efficiently determined by focusing on determining a moving feature point in the surrounding image, especially in a surrounding region of the boundary of the structure. When the structure is fixed and the structure moves on the surrounding image, the imaging position of the surrounding image moves relative to the structure. When the imaging position of the surrounding image moves relative to the structure, the contents of a row image when the surrounding image is converted into a time-series image are offset in at least one of the vertical direction or the horizontal direction in accordance with the movement of the imaging position of the surrounding image. When the row images arranged in the time-series image in the time-series order are offset in at least one of the vertical direction and the horizontal direction based on the movement speed of the structure on the surrounding image, the offset of the row image caused by the movement of the imaging position is canceled. By this cancellation, the contents of the row image captured during the movement of the imaging position and the contents of the row image captured before or after the movement are matched in at least one of the vertical direction or the horizontal direction on the time-series image 29. The movement speed of the moving feature point in the surrounding image is the relative movement speed of the moving feature point with respect to the surrounding image. The relative movement of the moving feature point with respect to the surrounding image includes the relative movement of the moving feature point due to the movement of the imaging position of the surrounding image. By detecting the movement of the imaging position of the surrounding image and detecting the distance from the imaging position to the object corresponding to the moving feature point in the surrounding image, the relative movement speed of the moving feature point on the surrounding image can be converted into an absolute movement speed based on the detected movement and the distance. The surrounding moving object can be recognized with high accuracy using the converted absolute movement speed.

In each embodiment above, the moving object recognition device 1 is mounted in the vehicle 100, so that a moving object around the vehicle 100 can be suitably recognized on the surrounding image which is captured from the vehicle 100 and in which the surroundings of the vehicle 100 appears even when the moving object is partially hidden by an object in the foreground. The moving object recognition method may be executed using the moving object recognition device 1 without being mounted in the vehicle 100. The embodiment described above is an example of the present invention. Therefore, the present invention is not limited to the embodiment described above, and it is needless to say that various modifications may be made in accordance with the design or the like even in other embodiments as long as they do not depart from the technical concept of the present invention.

1. A moving object recognition method executed by a computer, the moving object recognition method comprising:
acquiring a plurality of surrounding images in a time series obtained by capturing surroundings a plurality of times in a time series;
extracting row images at two or more prescribed positions in a vertical direction different from each other, from each of the acquired plurality of surrounding images in the time series;
generating, for each of the two or more prescribed positions, a time-series image in which the extracted row images are arranged in the vertical direction in a time series order;
grouping the feature points of the time-series images that move between the row images and at which feature quantities in the row images vary, based on moving directions of horizontal positions of the feature points and on parameters corresponding to straight line components approximating time-series changes of the horizontal positions;
clustering two of the feature points into a same group when a moving speed difference between the horizontal positions of the two of the feature points that move between the row images is less than a prescribed value and a difference between the parameters of the two of the feature points is within a prescribed range; and
recognizing a moving object moving in the surroundings from the plurality of surrounding images in the time series based on a difference between the row images of each of the time-series images in the horizontal positions of the feature points clustered into the same group.

2. The moving object recognition method according to claim 1, further comprising:
extracting the feature point from each of the row images of each of the time-series images; and
detecting the difference between the row images of each of the time-series images in the horizontal position of the extracted feature point.

3. The moving object recognition method according to claim 1, further comprising
extracting an edge portion in each of the row images of each of the time-series images as the feature point.

4. The moving object recognition method according to claim 1, further comprising
extracting the feature point in each of the row images of each of the time-series images based on a negative variation of the feature quantity in a horizontal direction.

5. The moving object recognition method according to claim 1, further comprising
recognizing the moving object based on a moving speed of the feature point whose horizontal position moves between the row images of each of the time-series images.

6. (canceled)

7. The moving object recognition method according to claim 1, further comprising
recognizing the moving object when a score, which becomes higher as the grouped feature points in each of the time-series images extend longer in the vertical direction, is equal to or greater than a prescribed determination threshold.

8. The moving object recognition method according to claim 1, further comprising
recognizing the moving object in a surrounding region of a boundary of a structure present in the surrounding image.

9. The moving object recognition method according to claim 8, further comprising
arranging, in the time-series images, each of the row images at a position offset from the two or more prescribed positions in the vertical direction based on a moving speed of the structure on the surrounding image.

10. A moving object recognition device comprising a computer, wherein the computer is configured to:
acquire a plurality of surrounding images in a time series obtained by capturing the surroundings a plurality of times in a time series;
extract row images at two or more prescribed positions in a vertical direction different from each other, from each of the acquired plurality of surrounding images in the time series;
generate, for each of the two or more prescribed positions, a time-series image in which the extracted row images are arranged in the vertical direction in a time-series order;
group feature points of the time-series images that move between the row images and at which the feature quantities in the row images vary, based on moving directions of horizontal positions of the feature points and on parameters corresponding to straight line components approximating time-series changes of the horizontal positions;
cluster two of the feature points into a same group when a moving speed difference between the horizontal positions of the two of the feature points that move between the row images is less than a prescribed value and a difference between the parameters of the two of the feature points is within a prescribed range; and
recognize a moving object moving in the surroundings from the plurality of surrounding images in the time series based on a difference between the row images of each of the time-series images in the horizontal positions of the feature points clustered into the same group.
